(19) United States
(12) Patent Application Publication
(10) Pub. No.: US 2008/0142111 A1
(43) Pub. Date: Jun. 19, 2008

(54) FUEL TANK VENTING SYSTEM AND METHOD

(76) Inventors: Mark Osterbrink, Rochester Hills, MI (US); Paul Luft, Novi, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/612,707

(22) Filed: Dec. 19, 2006

(51) Int. Cl. B60K 15/035

(52) U.S. Cl. 141/59; 220/746; 141/7

(57) ABSTRACT

This invention provides a fuel tank venting system for regulating the discharge of fuel vapors and of liquid fuel from a fuel tank. The fuel tank venting system includes fuel vapor vent tubes that are fully enclosed within the system and exit the fuel tank at a common location. Because the fuel vapor vent tubes are fully enclosed within the system, vent valves are not required at each vent point and permeation resistant tubing is not required. In this fuel tank venting system fuel is prevented from reaching the fuel vapor recovery canister under normal operating conditions and the fuel filler pipe serves as a liquid/vapor discriminator. In another embodiment the vent vapor tube does not extend beyond the highest fuel level in the fuel filler pipe because the fuel filler pipe pressure is lower than the fuel tank pressure due to the fuel filler pipe connectivity to the canister.

### FIELD OF THE INVENTION

This invention relates generally to automotive fuel tanks. More specifically, this invention relates to a fuel tank venting system and associated method for regulating the discharge of fuel vapors and of liquid fuel from a fuel tank. The fuel tank venting system includes at least one fuel vapor vent tube that is wholly disposed within the fuel tank and fuel filler pipe. Because at least one fuel vapor vent tube is wholly disposed within the fuel tank and fuel filler pipe, vent valves are not required at each vent point and permeation resistant tubing is not required. In this fuel tank venting system, fuel is prevented from reaching the fuel vapor recovery canister under normal operating conditions, and the fuel filler pipe serves as a liquid/vapor discriminator.

### BACKGROUND OF THE INVENTION

Current automotive fuel tank venting systems require a vent valve at each vent point and use permeation resistant tubing. The vent valves are coupled to a fuel tank and used to discharge fuel vapor located in the fuel tank to an external location outside of the fuel venting system. The permeation resistant tubing is required so that fuel located in the fuel tank does not permeate the tubing. Permeation can cause non-compliance with emission regulations. Additionally, current fuel tank venting systems may permit fuel to reach the fuel vapor recovery canister under some operating conditions. For example, if any failure occurs at a vent valve, liquid fuel may reach the canister. Since the fuel vapor recovery canisters are often made of charcoal, the presence of any liquid fuel in the canister will deteriorate it. Furthermore, current fuel tank venting systems generally use external vent lines, an external liquid/vapor separator, multiple moving parts, springs, and floats. A typical vent valve consists of a member that is buoyant in fuel contained in a housing with a communication path between the fuel tank and vapor system. The member is generally in a position that leaves the communication path open, and moves when the fuel level rises to close the path between the fuel tank and vapor system. If any of the multiple components in the valve fail, or it responds too slowly to the rising fuel level, liquid fuel can be transported directly to the canister. Therefore, the need exists for an automotive fuel tank venting system which overcomes these many known deficiencies in the art, and in particular does not require fuel vapor vent valves, and uses a fuel vapor vent tube wholly disposed within a fuel tank and fuel filler pipe of the fuel tank venting system.

A variety of fuel tank venting systems, and like devices, have been described previously and are known in the related art. None of the fuel tank venting systems however, are designed to solve the particular problem addressed by the present invention and none are capable of being modified to do so. For example, U.S. Pat. No. 4,836,402 issued to Sasaki on Jun. 6, 1989 discloses a plurality of vent tubes in communication with a separator chamber, and the use of one vent tube outside of the fuel tank to vent fuel vapors to a canister. Similarly, U.S. Pat. No. 5,343,905 issued to Gryc et al. on Sep. 6, 1994 discloses a vapor vent assembly that is inserted through the top of the fuel tank, and uses one vent tube outside of the fuel tank to vent to a canister. Similarly, U.S. Patent Application Publication No. 2005/0022898, published on Feb. 3, 2005 and filed by Williamson et al., discloses a fuel vapor vent valve mounted in the top of a fuel tank and externally venting fuel vapors to a vent tube and a canister. None of Sasaki, Grye et. al., or Williamson et al. discloses a fuel vapor vent tube that is wholly disposed within the fuel tank and fuel filler pipe. Therefore, a need still exists for a new automotive fuel tank venting system that overcomes these deficiencies.

### BRIEF SUMMARY OF THE INVENTION

In various exemplary embodiments, the present invention provides an automotive fuel tank venting system for regulating the discharge of fuel vapors from a fuel tank into a fuel filler pipe and fuel vapor recovery canister without the use of fuel vapor vent valves, moving parts, float springs, or floats. The fuel vapor vent tubes used within the fuel tank venting system are not externally vented with vent valves in any manner, or with vent tubes located outside of the fuel tank and fuel filler pipe. The fuel vapor vent tubes are wholly disposed within the fuel tank and fuel filler pipe and have vent points at each end.

In one exemplary embodiment, the present invention provides an automotive fuel tank venting system including a fuel tank, a fuel filler pipe coupled to the fuel tank, a fuel vapor vent tube disposed within the fuel tank and fuel filler pipe, a vent point at each end of the fuel vapor vent tube, and a vent to a fuel vapor recovery canister, the vent being located within the fuel filler pipe. The fuel vapor vent tube is wholly disposed within the fuel tank and the fuel filler pipe. The vent point within the fuel tank, the height of the fuel vapor recovery canister vent in the fuel filler pipe, and the fuel vapor vent tube in the fuel filler pipe are located at a predetermined height to prevent siphoning of fuel from the fuel tank, while not exceeding a predetermined pressure level in the fuel tank, thus preventing fuel from traveling from the fuel tank to the fuel vapor recovery canister. Having the fuel vapor vent tube or tubes located within the fuel filler pipe as in the present invention serves as a liquid/vapor discriminator, without the need for a separate add-on conventional liquid/vapor discriminator. Due to the fuel vapor bent tube being contained inside the fuel tank and fuel filler pipe, it may optionally be constructed from a high permeability material. The fuel vapor vent tube is terminated at a point in the fuel filler pipe at a point lower in the fuel filler pipe than the vent to the fuel vapor recovery canister. The automotive fuel tank venting system is adapted to regulate the discharge of fuel vapors from a fuel tank without the use of moving parts, vent valves, springs, and floats. The vent points regulate fuel vapors by internally venting the fuel vapors within the fuel tank venting system. Optionally, the automotive fuel tank venting system includes more than one fuel vapor vent tube, and the number of fuel vapor vent tubes used in the system is determined based upon fuel tank geometry calculations and the venting needs of the fuel tank. The automotive fuel tank venting system includes a common exit point on the fuel tank leading to the fuel filler pipe, wherein more than one fuel vapor vent tubes pass through the common exit point into the fuel filler pipe. Optionally, the automotive fuel tank venting system includes an inlet check valve, located at the fuel tank inlet. The vent vapor tube does not need to extend beyond the highest fuel level in the fuel filler pipe in this embodiment because the fuel filler pipe pressure is lower than the fuel tank pressure due to the fuel filler pipe connectivity to the canister.

In another exemplary embodiment, the present invention provides a method of venting an automotive fuel tank without moving parts, vent valves, springs, or floats, including providing a fuel tank, providing a fuel filler pipe coupled to the fuel tank, inserting a fuel vapor vent tube wherein the fuel vapor vent tube is disposed within the fuel tank and fuel filler pipe, providing a vent point at each end of the fuel vapor vent tube, and inserting a vent to a fuel vapor recovery canister, the vent being located within the fuel filler pipe. The fuel vapor vent tube is wholly disposed within the fuel tank and the fuel filler pipe. The vent point within the fuel tank, the height of the fuel vapor recovery canister vent in the fuel filler pipe, and the fuel vapor vent tube in the fuel filler pipe are located at a predetermined height to prevent siphoning of fuel from the fuel tank, while not exceeding a predetermined pressure level in the fuel tank, thus preventing fuel from traveling from the fuel tank to the fuel vapor recovery canister. Having the fuel vapor vent tube or tubes located within the fuel filler pipe as in the present invention serves as a liquid/vapor discriminator, without the need for a separate add-on conventional liquid/vapor discriminator. Due to the fuel vapor vent tube being contained inside the fuel tank and fuel filler pipe, if may optionally be constructed from a high permeability material. The fuel vapor vent tube is terminated at a point in the fuel filler pipe at a point lower in the fuel filer pipe than the vent to the fuel vapor recovery canister. The automotive fuel tank venting method is adapted to regulate the discharge of fuel vapors from a fuel tank without the use of moving parts, vent valves, springs, and floats. The vent points regulate fuel vapors by internally venting the fuel vapors within the fuel tank venting system. Optionally, the automotive fuel tank venting method includes more than one fuel vapor vent tube, and the number of the fuel vapor vent tubes used in the method is determined based upon fuel tank geometry calculations and the venting needs of the fuel tank. The automotive fuel tank venting method further provides a common exit point on the fuel tank leading to the fuel filler pipe, wherein the fuel vapor vent tubes pass through the common exit point into the fuel filler pipe. Optionally, the automotive fuel tank venting system includes an inlet check valve, located at the fuel tank inlet. The vent vapor tube does not need to extend beyond the highest fuel level in the fuel filler pipe in this embodiment because the fuel filler pipe pressure is lower than the fuel tank pressure due to the fuel filler pipe connectively to the canister.

Advantageously, the automotive fuel tank venting system and method of the present invention overcome many of the deficiencies known in the art pertaining to fuel tank vent systems. The automotive fuel tank venting system and method do not require a vent valve at each vent point and do not require the use of permeation resistant tubing, as do current fuel tank venting systems. Additionally, the automotive fuel tank venting system and method prevents fuel from reaching the fuel vapor recovery canister during normal operations. Furthermore, the automotive fuel tank venting system of the present invention uses a fuel vapor vent tube that is wholly disposed within the fuel tank and fuel filler pipe, thus greatly reducing the complexity of the fuel tank vent systems known in the art.

There has thus been outlined, rather broadly, the features of the present invention in order that the detailed description that follows may be better understood, and in order that the present contribution to the art may be better appreciated. There are additional features of the invention that will be described and which will form the subject matter of the claims. Additional aspects and advantages of the present invention will be apparent from the following detailed description of an exemplary embodiment which is illustrated in the accompanying drawings. The invention is capable of other embodiments and of being practiced and carried out in various ways. Also, it is to be understood that the phraseology and terminology employed are for the purpose of description and should not be regarded as limiting.

### BRIEF DESCRIPTION OF THE DRAWINGS

The present invention is illustrated and described herein with reference to the various drawings, in which like reference numbers denote like system components and/or method steps, as appropriate, and in which:

FIG. 1 is a side planar view of a fuel tank venting system, according to an embodiment of the present invention, illustrating the placement of the fuel vapor vent tubes and vent points wholly disposed within the fuel tank and fuel filler pipe;

FIG. 2 is a top planar view of the fuel tank venting system illustrated in FIG. 1;

FIG. 3 is a side planar view of the fuel tank venting system illustrated in FIGS. 1 and 2, further illustrating potential fuel levels based upon movement of the automobile and the placement of the fuel vapor vent tubes in relation to the potential fuel levels; and

FIG. 4 is a side planar view of the fuel tank venting system according to an embodiment of the present invention, illustrating the use an inlet check valve and shorter vent vapor tubes that terminate just inside the fuel filler pipe, opposite the inlet check valve.

### DETAILED DESCRIPTION OF THE INVENTION

Before describing the disclosed embodiments of the present invention in detail, it is to be understood that the invention is not limited in its application to the details of the particular arrangement shown here since the invention is capable of other embodiments. Also, the terminology used herein is for the purpose of description and not of limitation.

The present invention provides a fuel tank venting system 10 for regulating the discharge of fuel vapors from a fuel tank 12. The fuel vapor vent tubes 20 are wholly disposed within the fuel tank 12 and fuel filler pipe 14. The fuel vapor vent tubes 20 exit the fuel tank 12 at a common exit location 16 before entering the fuel filler pipe 14. Liquid fuel is prevented from reaching the fuel vapor recovery canister 30. Having the one end of the fuel vapor vent tube located in the fuel filler pipe 14 as shown serves as a liquid/vapor discriminator, without the need for a separate add-on conventional liquid/vapor discriminator. Fuel vapor vent valves are not required at each vent point 22. Permeation resistant tubing is not required in the fuel tank venting system 10.

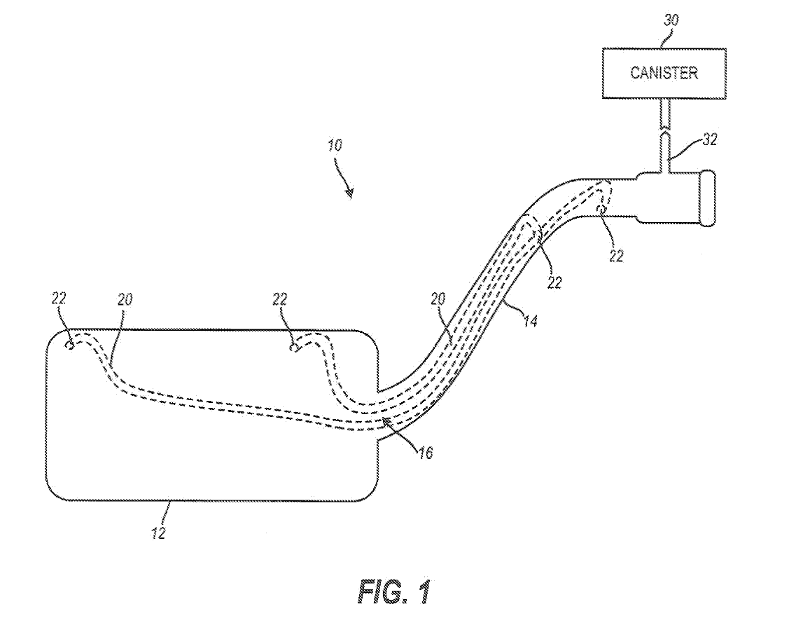

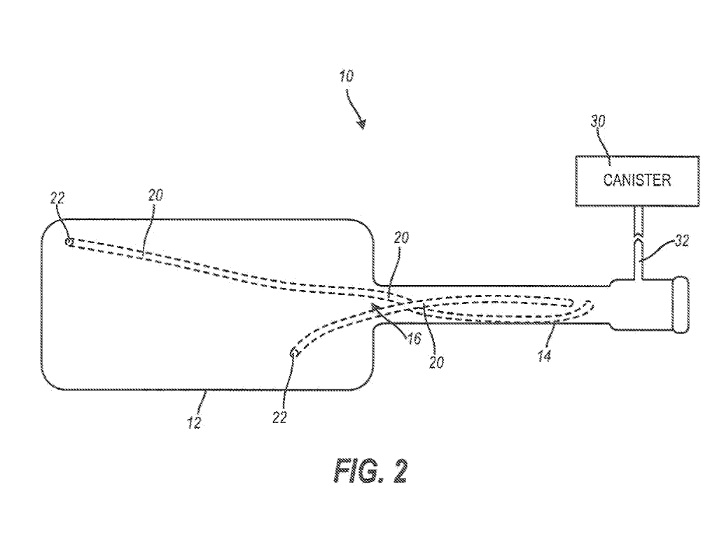

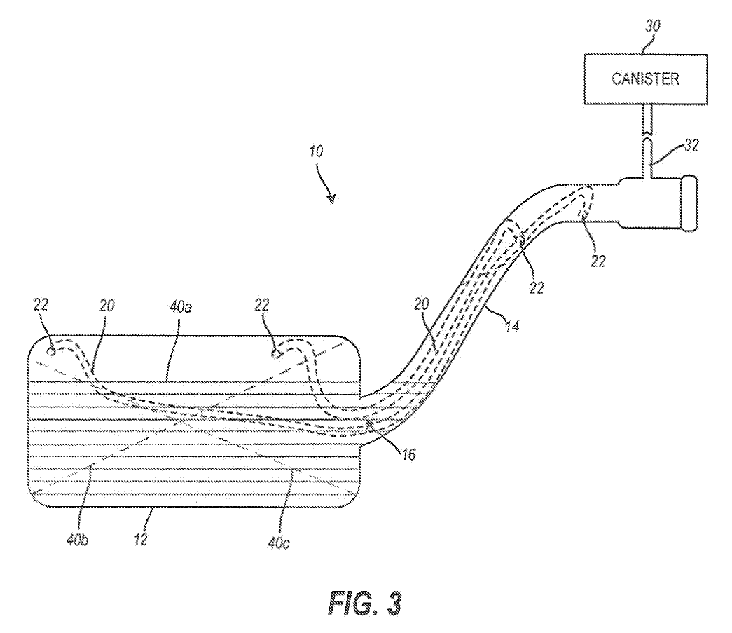

Referring now to FIGS. 1 and 2, an automotive fuel tank venting system 10 is shown. The automotive fuel tank venting system 10 includes a fuel tank 12 and a fuel filler pipe 14 coupled to the fuel tank 12. The fuel tanks 12 and fuel filler pipes 14 are well known in the art and are constructed of various materials. The fuel tank 12 capacity for the liquid fuel varies, but as fuel is consumed, there is additional room in the fuel tank 12 for vapors. For example, a large fuel tank has a capacity of twenty six gallons of liquid fuel. The fuel tank 12 is adapted to have a vacant air space above the fuel level (see FIG. 3, 40a) even when the fuel tank 12 is maximally filled.

The fuel tank 12 must be vented to allow for liquid fuel to be drawn out. Therefore, the automotive fuel tank venting system 10 includes at least one fuel vapor vent tube 20 disposed within the fuel tank 12 and fuel filler pipe 14. The fuel vapor vent tube 20, at least one is used, used within the system is not externally vented and is thus located wholly disposed within the fuel tank 12 and fuel filler pipe 14 exclusively. There are no external vent valves in this automotive fuel tank venting system 10. The fuel vapor vent tube 20 is manufactured of various materials and in various sizes. The fuel vapor vent tube 20 may be manufactured from alternative materials so long as the alternative materials are not degraded by the liquid fuel environment within the fuel tank 12.

The number of the fuel vapor tubes 20 used in the fuel tank venting system 10 is determined based upon fuel tank 12 geometry calculations, wherein the size of the fuel tank 12, the shape of the fuel tank 12, and the venting needs of the fuel tank 12 are taken into consideration. Thus, the more fuel vapor venting required, based on the size and shape of the fuel tank 12, the more fuel vapor vent tubes 20 are needed and installed in the fuel tank 12. A minimum of one fuel vapor vent tube 20 is needed; however, in practice, the number of fuel vapor tubes 20 used may be higher as venting requirements necessitate. Two fuel vapor vent tubes 20 are show in each of FIGS. 1, 2, and 3. While current automotive fuel tank venting systems use permeation resistant tubing, the present invention optionally includes the use of permeating tubing materials.

The fuel vapor vent tubes 20 used in the fuel tank venting system 10 are maintained in the fuel tank 12 through a variety of means. The fuel vapor vent tubes 20 are free-floating, floating on the surface of liquid fuel in the fuel tank 12, and supported against the walls of the fuel filler pipe 14. In alternative embodiments, the fuel vapor vent tubes 20 are secured to the walls of the fuel tank 12 and the fuel filler pipe 14. In yet another alternative embodiment, the fuel vapor vent tubes are also secured at the juncture of the fuel tank 12 and the fuel filler pipe 14 by an inlet check valve (not shown).

The automotive fuel tank venting system 10 also includes a vent point at each end of the fuel vapor vent tube 20. The fuel vapor vent tube 20 is generally curved at each end. Each of the fuel vapor vent tubes 20 serves as a vent point 22. These multiple vent points 22 regulate fuel vapors by internally venting within the fuel tank venting system 10. The fuel tank venting systems known in the art generally have a vent valve and/or a vapor separator on an external edge of the fuel tank 12 prevent liquid fuel from escaping and to allow fuel vapor to pass through an eternal vapor tube to a fuel vapor recovery canister. All venting from this automotive fuel tank venting system 10 occurs within the fuel tank 12 and the fuel filler pipe 14.

The automotive fuel tank venting system 10 also includes a vent 32 to a fuel vapor recovery canister 30. The vent 32 is located within the fuel filler pipe 14. The fuel vapor vent tube 20 is terminated at a point in the fuel filler pipe 14 at a point lower in the fuel filler pipe 14 than the vent 32 to the fuel vapor recovery canister 30. The fuel vapor recovery canister 30 is of a type well known in the art an services as an evaporative emission control system. A fuel vapor recovery canister 30 is often manufactured incorporating an activated charcoal for control of emission vapors. Fuel vapors from the fuel tank 12 are routed from the fuel tank 12 through the fuel vapor vent tube 20 into the fuel filler pipe 14 and out the vent 32 to the fuel vapor recovery canister 30, where the vapors are routed through an activated charcoal.

The automotive fuel tank venting system 10 also includes a common exit location 16 to the fuel tank. When multiple fuel vapor vent tubes 20 are implemented, each fuel vapor tube 20 is routed from the fuel tank 12 through the common exit point 16 into the fuel filler pipe 14. In an alternative embodiment, the fuel vapor vent tubes are also secure at the common exit point 16 of the fuel tank 12 by an inlet check valve (not shown).

The automotive fuel tank venting system 10 is adapted to regulate the discharge of fuel vapors and liquid fuel from a fuel tank 12 without the use of moving parts, vent valves, springs, and floats. The system 10 does not require a vent valve at each vent point 22. The fuel tank venting system 10 vents fuel vapors internal to the system 10 without the need for vent valves having external outputs, thus overcoming an obvious deficiency of the fuel tank venting systems known in the art.

Current fuel tank venting systems 10 known in the art permit fuel to reach the fuel vapor recovery canister 30 under some operating conditions. The automotive fuel tank venting system 10 of the present invention is adapted to prevent fuel from reaching the fuel vapor recovery canister 30 during normal operating conditions. The fuel vapor recovery canister 30 is designed to capture and store hydrocarbons entrained in fuel vapors that are displaced and generated in the fuel tank during a typical vehicle operation or that are otherwise vented from the fuel tank. The presence of liquid fuel in the fuel vapor recovery canister 30 will degrade it overall effectiveness. Based on the geometric placement of the fuel vapor vent tube 20 in the fuel tank 12 and the fuel filler pipe 14, fuel is prevented from reaching the canister 30. Any vent point 22 within the fuel tank 12, the height of the vent 32 to the fuel vapor recovery canister 30 in the fuel filler pipe 14, and any fuel vapor vent tube 20 in the fuel filler pipe 14, are located at predetermined heights to prevent siphoning of fuel from the fuel tank 14, while at the same time not exceeding a predetermined pressure level in the fuel tank, thus, preventing fuel from traveling from the fuel tank 12 to the fuel vapor recovery canister 30.

Additionally, the combination of the fuel vapor vent tube 20 located within the fuel filler pipe 14 creates a liquid/vapor discriminator. A liquid/vapor discriminator is known in the art. A liquid/vapor discriminator acts to separate liquid from vapor, allowing vapors to pass and disallowing liquid fuel from passing. With the liquid/vapor discriminators known in the art, this function generally occurs on the perimeter edge of a fuel tank. In the present invention, however, the separation of vapors and fuel occurs in the fuel filler pipe 14. Fuel vapors that exit in the fuel filler pipe 14 are vented through the vent 32 to the fuel vapor recovery canister 30.

Referring now to FIG. 3, an automotive fuel tank venting system 10 is shown. In addition to references first shown in FIGS. 1 and 2, the various sample fuel levels 40a, 40b, and 40c, based upon various movements of the automobile and the placement of the fuel vapor vent tubes 20 in relation to the potential fuel levels 40a, 40b, and 40c, are illustrated.

Fuel level 40a shows an example fuel level in the fuel tank 12 while the automotive vehicle is at rest on a horizontally level surface. Fuel level 40b shows an example fuel level in the fuel tank 12 while the automotive has turned in one direction or is otherwise slanted relative to the level at-rest position on a level surface. Fuel level 40c shows an example fuel level in the fuel tank 12 while the automotive vehicle is turning or otherwise slanted in the opposite direction as that shown with fuel level 40b. Fuel levels 40b and 40c, and the calculated placement of the fuel vapor vent tubes 20 within the fuel filer pipe 14, illustrate how fuel cannot be siphoned out of the fuel tank 12 and into the fuel filler pipe 14. No matter what the fuel level, 40a, 40b, or 40c, the ends of fuel vapor vent tubes 20 located in the fuel tank 12 remain above the liquid fuel, and thus to do not siphoned fuel into the fuel filler pipe.

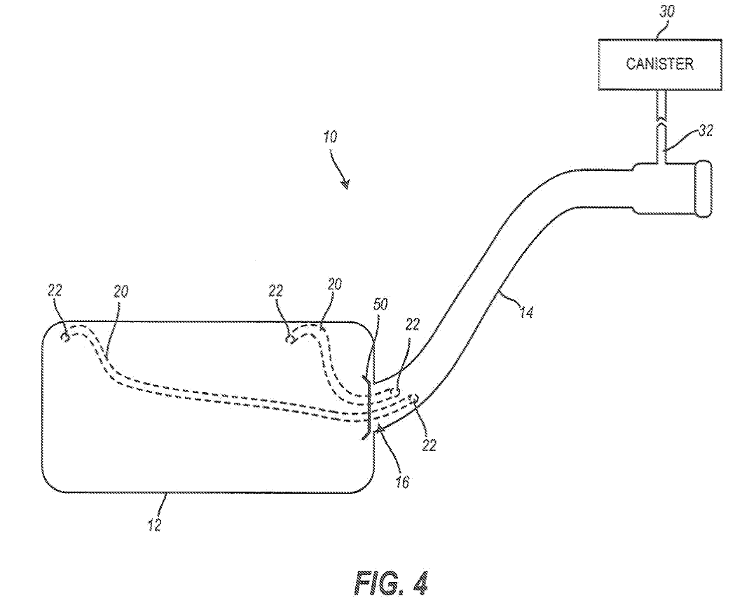

Referring now to FIG. 4, an automotive fuel tank venting system 10 is shown. In an alternative embodiment to the fuel tank venting system 10 shown in FIGS. 1, 2, and 3, this fuel tank venting system 10 uses vent vapor tubes 20 which are considerably shorter. Additionally, this fuel tank 12 includes an inlet check valve 50 in the fuel tank 12. The inlet check valve 50 allows fuel to enter into the fuel tank 12 from the fuel filler pipe 14; however, the inlet check valve 50 does not allow fuel to leave the fuel tank 12 in the opposite direction and enter into the fuel filler pipe 14. In a fuel tank 12 using an inlet check valve 50 at the fuel tank inlet, shorter vent vapor tubes 20 are used. Thus, the vent vapor tubes 20 do not need to extend beyond the highest fuel level in the fuel filler pipe 14 because the fuel filler pipe 14 pressure will be lower than the fuel tank 12 pressure due to the fuel filler pipe 14 connectivity to the canister 30.

Although the present invention has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. An automotive fuel tank venting system comprising:
a fuel tank;
a fuel filler pipe coupled to the fuel tank;
a fuel vapor vent tube disposed within the fuel tank and fuel filler pipe;
a vent point at each end of the fuel vapor vent tube; and
a vent to a fuel vapor recovery canister, the vent being located within the fuel filler pipe.

2. The automotive fuel tank venting system of claim 1, wherein the fuel vapor vent tube is wholly disposed within the fuel tank and the fuel filler pipe.

3. The automotive fuel tank venting system of claim 1, wherein the vent point within the fuel tank, the height of the fuel vapor recovery canister vent in the fuel filler pipe, and the fuel vapor vent tube in the fuel filler pipe are located at a predetermined height to prevent shipping of fuel from the fuel tank, while not exceeding a predetermined pressure level in the fuel tank, thus preventing fuel from traveling from the fuel tank to the fuel vapor recovery canister.

4. The automotive fuel venting system of claim 1, wherein the fuel vapor vent tube located within the fuel filler pipe is a liquid/vapor discriminator.

5. The automotive fuel tank venting system of claim 1, wherein the fuel vapor vent tube is comprised of a permeating material.

6. The automotive fuel tank venting system of claim 1, wherein the fuel vapor vent tube is terminated at a point in the fuel filler pipe at a point lower in the fuel filler pipe than the vent to the fuel vapor recovery canister.

7. The automotive fuel tank venting system of claim 1,
wherein the automotive fuel tank venting system is adapted to regulate the discharge of fuel vapors from a fuel tank without the use of moving parts, vent valves, springs, and floats; and
wherein the vent points regulate fuel vapors by internally venting the fuel vapors within the fuel tank venting system.

8. The automotive fuel tank venting of claim 1, comprising
an inlet check valve, located at an inlet to the fuel tank;
wherein the vent vapor tube does not need to extend beyond the highest fuel level in the fuel filler pipe because the fuel filler pipe pressure is lower than the fuel tank pressure due to the fuel filler pipe connectivity to the canister.

9. The automotive fuel tank venting system of claim 1, comprising more than one fuel vapor vent tube, and the quantity of the more than one fuel vapor vent tubes used in the system is determined based upon fuel tank geometry calculations and the venting needs of the fuel tank.

10. The automotive fuel tank venting system of claim 9, further comprising a common exit point on the fuel tank leading to the fuel filler pipe, wherein the more than one fuel vapor vent tubes pass through the common exit point into the fuel filler pipe.

11. A method of venting an automotive fuel tank without moving parts, vent valves, springs, or floats, comprising:
providing a fuel tank;
providing a fuel filler pipe coupled to the fuel tank;
inserting a fuel vapor vent tube, wherein the fuel vapor tube is disposed within the fuel tank and fuel filler pipe;
providing a vent point at each end of the fuel vapor vent tube; and
inserting a vent to a fuel vapor recovery canister, the vent being located within the fuel filler pipe.

12. The method of venting an automotive fuel tank without moving parts, vent valve, springs, or floats of claim 11, wherein the fuel vapor vent tube is wholly disposed within the fuel tank and the fuel filler pipe.

13. The method of venting an automotive fuel tank without moving parts, vent valves, springs, or floats of claim 11, wherein the vent point within the fuel tank, the height of the fuel vapor recovery canister vent in the fuel filler pipe, and the fuel vapor vent tube in the fuel filler pipe are located at a predetermined height to prevent siphoning of fuel from the fuel tank, while not exceeding a predetermined pressure level in the fuel tank, thus presenting fuel from traveling from the fuel tank to the fuel vapor recovery canister.

14. The automotive fuel tank venting system of claim 1, wherein the fuel vapor vent tube located within the fuel filler pipe is a liquid/vapor discriminator.

15. The method of venting an automotive fuel tank without moving parts, vent valves, springs, or floats of claim 11, wherein the fuel vapor vent tube is comprised of a permeating material.

16. The method of venting an automotive fuel tank without moving parts, vent valves, springs, or floats of claim 11, wherein the fuel vapor vent tube is terminated at a point in the fuel pipe at a point lower in the fuel filler pipe than the vent to the fuel vapor recovery canister.

17. The method of venting an automotive fuel tank without moving parts, vent valves, springs, or floats of claim 11,
wherein the automotive fuel tank venting system is adapted to regulate the discharge of fuel vapors from a fuel tank without the use of moving parts, vent valves, springs, and floats; and
wherein the vent points regulate fuel vapors by internally venting the fuel vapors within the fuel tank venting system.

18. The method of venting an automotive fuel tank without moving parts, vent valves, springs, or floats of claim 11, comprising
providing an inlet check valve, located at an inlet to the fuel tank;
wherein the vent vapor tube does not need to extend beyond the highest fuel level in the fuel filler pipe because the fuel filler pipe pressure is lower than the fuel tank pressure due to the fuel filler connectivity to the canister.

19. The method of venting an automotive fuel tank without moving parts, vent valves, springs, or floats of claim 11, comprising more than one fuel vapor vent tube, and the quantity of the more than one fuel vapor vent tubes used in the system is determined based upon fuel tank geometry calculations and the venting needs of the fuel tank.

20. The method of venting an automotive fuel tank without moving parts, vent valves, springs, or floats of claim 19, further comprising a common exit point on the fuel tank leading to the fuel filler pipe, wherein the more than one fuel vapor vent tubes pass through the common exit point into the fuel filler pipe.
